(19) United States
(12) Patent Application Publication
(10) Pub. No.: US 2025/0369517 A1
(43) Pub. Date: Dec. 4, 2025

(54) NON-CONTACT DYNAMIC SEAL FOR SEALING A RADIAL GAP

(71) Applicant: ebm-papst Mulfingen GmbH & Co. KG, Mulfingen (DE)

(72) Inventors: Ahmet Coksen, Schwaebisch Hall (DE); Emre Karaefe, Mulfingen (DE)

(21) Appl. No.: 19/217,103

(22) Filed: May 23, 2025

(30) Foreign Application Priority Data
May 29, 2024 (DE) 10 2024 115 122.6

(51) Int. Cl. F16J 15/447; F04D 29/16

(52) U.S. Cl. CPC F16J 15/447; F04D 29/162

(57) ABSTRACT

Non-contact dynamic seal for sealing a radial gap has an internal sealing body and an external sealing body with a receiving space for receiving the internal sealing body. Internal sealing body is conical and tapered step-wise with steps each defined by a radial external surface and an axial external surface. Receiving space is conical and tapered step-wise with steps each defined by a radial internal surface and an axial internal surface. Each radial external surface is associated with a radial internal surface and adjacent to one another in a non-contact manner forming a radial sealing gap. Each respective axial external surface is associated with an axial internal surface spaced apart in the axial direction, to form a swirl chamber for fluid between corresponding axial external surfaces and axial internal surfaces connected to one another via the radial sealing gaps acting as fluid restrictors.

### DESCRIPTION

The invention relates to a non-contact dynamic seal, which may also be referred to as a labyrinth seal, for sealing a radial gap. In particular, it refers to a seal for centrifugal compressors or generally for applications involving high rotational speeds of more than 50,000 rpm, for example.

Small centrifugal compressors in particular, having high rotational speeds of typically more than 50,000 rpm, usually require the use of non-contact seals to minimize a parasitic leakage flow of a fluid to be compressed, in particular through a radial gap between a rotating impeller or its rotating support plate and a stationary rear wall of the impeller or machine housing.

Commonly, labyrinth seals are employed for this purpose. In some cases, labyrinth seals with thin, annular fins are employed, strictly delimiting areas within the radial gap from one another in the axial direction, thus forming individual swirl chambers, with the fins acting as fluid restrictors between the swirl chambers at the same time. Labyrinth seals in general are known from document DE 39 40 607 A1, for example.

Moreover, successively stepped fins and swirl chambers are also known, which correspondingly implement different seal radii, thereby improving control over and reducing the leakage flow passing inside the swirl chambers and through the restrictors.

In particular, the option to arrange step seals on conical surfaces is useful for design reasons as it allows to particularly easily insert a shaft forming part of the seal into the receptacle forming the counterpart of the shaft.

Various variations of seals are known, for example, from documents DE 11 2015 006 062 T5, DE 11 2016 005 643 T5, DE 11 2018 000 966 T5, U.S. Pat. No. 8,784,046 B2, U.S. Pat. No. 9,429,022 B2, U.S. Pat. No. 10,557,363 B2, US 2019/0072185 A1, and DE 11 2015 006 039 T5, in which such fins for forming swirl chambers are combined with a stepped structure.

However, what these seals have in common is that they are expensive to manufacture due to the thin fins. Thus, the fins or ribs are often only a few tenths of millimeters in width, making the manufacture correspondingly complex when considering the production tolerances actually achievable. Added to that, a restricting effect accomplished by the fins is only controllable to a limited extent by means of the radial or axial extension thereof as the thickness of the fins in the axial direction has no or hardly any influence on the restricting effect, and a change in the radial extension directly interferes with the effect of the swirl chambers.

Therefore, an object of the invention is to overcome the above-mentioned drawbacks and to provide a non-contact dynamic seal as well as an associated device in which a flow resistance in the seal is able to be influenced by design or a leakage flow through the seal as well as the axial forces acting on the seal are adjustable in a targeted manner, and which is also inexpensive to manufacture.

In particular, it is also advantageous if axial forces acting on the support plate and more preferably on the surfaces of the support plate facing the radial gap or an impeller side space are adjustable by the seal in a targeted manner.

This object is achieved by the combination of features according to the main claim, and also according to the further independent claim.

Therefore, according to the invention, a non-contact dynamic seal is proposed, which may also be referred to as a labyrinth seal and/or radial seal. As such, the proposed seal serves to seal a radial gap between a radially inward internal body and a radially outward external body surrounding the internal body in a circumferential direction, which are rotatable relative to one another about an axis of rotation, wherein the internal body may rotate in the external body at a rotational speed of more than 50,000 rpm, for example. In particular, the proposed seal according to the invention may be employed for sealing a shaft carrying a vane wheel or impeller as the internal body with respect to a housing as the external body in a centrifugal compressor, for example.

To clarify, it should be noted that the seal is to increase a flow resistance for a fluid or leakage flow of a fluid through the radial gap reduced by the seal but does not necessarily have to prevent the leakage flow completely. Depending on the application, the fluid may be air, propane or even other gases, gas mixtures or refrigerants, for example. Similarly, the fluid may basically be liquids as well.

According to the invention, the seal has an internal sealing body providable on the internal body and an external sealing body providable on the external body, with a receiving space for receiving the internal sealing body. In this respect, the internal body may integrally form the internal sealing body, wherein the internal sealing body may alternatively also be arranged on the internal body as a separate component and may be fixed or fixable in the radial direction in a leak-proof or at least non-rotatable manner. Similarly, the external body may integrally form the external sealing body, wherein, again, the external sealing body may alternatively be arranged on the external body as a separate component and may be fixed or fixable in the radial direction in a leak-proof or at least non-rotatable manner.

In this respect, the radial gap to be sealed is formed preferably between the internal sealing body and the external sealing body, in particular wherein these are concentric to one another and to the axis of rotation and are arranged adjacent to one another to fully surround the latter in the circumferential direction.

Moreover, the internal sealing body has a conical basic shape and is tapered from a first side in the axial direction to a second side in a step-wise manner, i.e., by forming multiple steps, wherein the steps of the internal sealing body are each defined by a radial external surface and an axial external surface.

Similarly, as to the receiving space, it has a conical basic shape corresponding to the internal sealing body, and the receiving space is tapered from the first side in the axial direction to the second side in a step-wise manner, wherein the steps of the receiving space are each defined by a radial internal surface and an axial internal surface. Preferably, the internal sealing body is mounted axially and radially such that it can rotate in the receiving space in a fixed or constant axial positioning relative to the external sealing body in the circumferential direction about the axis of rotation without contacting the external sealing body. Each radial external surface is associated with a radial internal surface which are partially directly adjacent to or abutting one another in a non-contact manner forming a radial sealing gap. The radial internal surfaces overlap in the axial direction, i.e., each with a respective radial external surface. Further, each respective axial external surface is associated with an axial internal surface which are mounted directly next to and spaced apart or preferably at a predetermined distance from one another in the axial direction, wherein the respective axial external surface and the respective associated axial internal surface correspondingly overlap in the radial direction, so that a swirl chamber for receiving a fluid is formed between the axial external surfaces and a respective associated axial internal surface. The swirl chambers formed thereby are connected to each other through the radial sealing gaps acting as restrictors for the fluid.

Stated differently, each step of the internal sealing body is associated with the immediately adjacent step of the external sealing body, thus forming a pair, wherein the steps of the pair are arranged offset from one another in the axial direction, so that the radial surfaces of the pair, i.e., the respective radial external surface and the respective radial internal surface, are partially adjacent to one another or are partially free from one another, and the axial surfaces of the pair, i.e., the respective axial external surface and the respective axial internal surface, are spaced apart in the axial direction and thus a swirl chamber is formed directly between the steps of the pair. As the swirl chamber is preferably completely delimited or formed by the steps of the pair except for the sealing gap acting as a restrictor, disadvantageous fins as described in the beginning are not necessary.

As to the radial external and/or radial internal surfaces as well as the axial external and/or axial internal surfaces, these surround the axis of rotation, preferably fully and in an annular manner, wherein at least the radial internal surfaces may, preferably exclusively, extend in a respective single radial plane for each surface, and wherein the axial external and axial internal surfaces, preferably exclusively, extend in a respective single axial plane for each surface.

An advantageous variation of the invention provides for, on all or at least part of the radial external surfaces, a respective radial recess to be provided in the internal sealing body, extending the respective swirl chamber in the radial direction. As such, the radial recess may also be referred to as a groove or radial groove which extends in the internal sealing body, preferably fully surrounding the axis of rotation. In this way, a radial external surface having such a radial recess is divided into two portions, of which a first portion defined by the recess lies in a first radial plane, and a second portion free of the recess lies in a second radial plane, wherein the second radial plane correspondingly runs on a larger radius about the axis of rotation than the first radial plane. In this way, the swirl chamber is expanded, and the weight of the rotatable internal body is reduced by the removal of material at the same time.

In the axial direction, the respective radial recess may be delimited towards the first side by the respective axial external surface or preferably transitions into the same in a stepless manner.

Moreover, in the axial direction, the respective radial recess may be defined towards the second side or an interface of the recess towards the second side by the respective axial internal surface or be flush therewith.

This results in the swirl chambers to be preferably rectangular in the basic shape of their cross-section, wherein the edges of the swirl chamber may also be beveled, rounded or oval, for example. Accordingly, two of the edges of the rectangle are preferably parallel to the axis of rotation, and the two remaining edges of the rectangle are preferably orthogonal to the axis of rotation.

Where a radial recess is provided, it also divides the respective radial external surface in the axial direction into a first portion defined by the recess with a first axial width and a second portion free from the recess with a second axial width which in particular defines a restricting gap. As yet to be shown in tabular form, the ratio of the first axial width to the second axial width is in particular between 0.5 and 1.5, wherein the widths of the portions are preferably identical, so that the first axial width of the first portion is thus equal to the second axial width of the second portion. As such, the first axial width or the axial width of the first portion may also be referred to as a swirl chamber width, and the second axial width or the axial width of the second portion may also be referred to as a restrictor width.

The swirl chambers have a respective swirl chamber width in the axial direction and a respective swirl chamber depth in the radial direction. As such, in particular, the respective swirl chamber width is defined by the axial distance of the respective axial external surface to the respective internal surface, and the respective swirl chamber depth is at least partly defined by the extension of the axial external surface and of the sealing gap in the radial direction, wherein the swirl chamber depth may further be additionally defined by an optionally present recess or the recess depth. According to a first variation according to the invention, it is provided for the swirl chamber widths of the swirl chambers to vary from one another and/or for the swirl chamber depths of the swirl chambers to vary from one another and further preferably vary or be chosen such that, in each swirl chamber, a respective predetermined flow resistance or turbulent flow is caused for a predetermined leakage flow.

In principle, what also applies is that the sealing gaps each forming a restrictor have a respective restrictor width in the axial direction and have a respective restrictor depth in the radial direction. As such, in particular, the respective restrictor width is defined by an axial length of the partial overlap of the respective radial external surface with the respective radial internal surface, and the respective restrictor depth is defined by the radial distance of the respective radial external surface from the respective radial internal surface. According to a second variation according to the invention, which may be combined with the first variation according to the invention or be an alternative thereto, it is provided for the restrictor widths of the sealing gaps to vary from one another and/or for the restrictor depths of the sealing gaps to vary from one another, and in particular to vary or be chosen such that, with each sealing gap or in each restrictor, a predetermined restricting effect, i.e., for a predetermined leakage flow, a predetermined flow resistance is caused.

Contrary to prior art which usually requires a multi-part design because of the chosen fins, it is preferably provided herein that the internal sealing body is integral, wherein the external sealing body may also be integral. Accordingly, it is not necessary to respectively fix additional components for forming the swirl chambers and restrictors on the internal and/or external sealing bodies. If the internal sealing body is provided integrally with the internal body, the latter may also be integrally formed accordingly. Analogously, this also applies to the external sealing body.

Moreover, it is preferably provided for the swirl chambers and the radial sealing gaps to be formed, in particular, by correspondingly chosen dimensions or radial positioning of the swirl chambers and sealing gaps, to produce a predetermined axial force from the fluid flowing in the swirl chambers and sealing gaps at the internal sealing body at a predetermined rotation of the internal body relative to the external body or the internal sealing body relative to the external sealing body, i.e., at a predetermined rotational speed, by which other axial forces acting on the internal sealing body may be compensated. In this way, a predetermined axial force on the internal sealing body may be produced by the fluid flowing between the internal sealing body and the external sealing body at an operating point of a compressor, for example, predetermined by the rotational speed, in particular, by which other axial forces on the internal sealing body may also be compensated or the resulting axial force acting on the internal sealing body is reduced to a predetermined extent.

A further aspect of the invention relates to a device which may be a compressor, in particular, and further preferably be a centrifugal compressor. The device has a housing and an impeller mounted in the housing rotatably about an axis of rotation, wherein the housing, in particular in the case of a centrifugal compressor, may also be referred to as a machine housing. In the proposed device, the impeller is integrally formed as an internal body rotatable about the axis of rotation or fixed to a shaft which is formed as the internal body rotatable about the axis of rotation. Analogously, the housing is integrally formed as a radially outward external body surrounding the internal body in the circumferential direction or receives the external body which surrounds the internal body in the circumferential direction. In this case, a radial gap formed between the internal body and the external body, which is required to enable the rotation of the impeller with respect to the housing, is sealed by a proposed seal according to the invention.

Preferably, it is further provided for the internal sealing body of the seal to be fixed to the internal body, or further preferably for the internal body to be integrally formed as an internal sealing body of the seal, so that the internal body can thus integrally form, i.e., as single piece, the impeller and the internal sealing body. Similarly, the external sealing body may be fixed to the external body, or it is preferably provided for the external body to be integrally formed as the external sealing body.

As already explained in relation to the seal, it may be provided for a predetermined axial force acting on the internal sealing body to be able to be produced by the swirl chambers and sealing gaps or the fluid flowing therethrough at a predetermined rotational speed or a predetermined operating point of the device. Based on the device or the centrifugal compressor, it is correspondingly further preferably provided for the swirl chambers and the radial sealing gaps to be formed, or for the seal in general to be formed, such that, at a predetermined rotation, i.e., rotational speed, of the impeller about the axis of rotation or at a predetermined operating point of the impeller, a predetermined axial force for compensation and/or for reduction of opposing axial forces acting on the internal sealing body and/or the impeller can be produced by the fluid passing through the swirl chambers or the sealing gaps, so that, accordingly, other axial forces produced at the impeller by the rotation of the impeller can be compensated or at least reduced. Accordingly, the seal may implement axial thrust compensation or at least axial thrust reduction at the impeller, so that, at a predetermined operating point of the device, the axial force resulting from the sum of all axial forces affecting the impeller is zero at the impeller or is within the predetermined load limits of an axial bearing of the impeller.

Specifically, the seal allows to change the radial distribution of the static pressure in the impeller side space at the side of the support plate such that this results in the predetermined axial force acting on the support plate. For example, a corresponding radial positioning of the seal may implement an axial thrust compensation (equilibrium of forces) of all forces acting on the impeller, or the resulting axial forces may be reduced to an extent lying within the predetermined load limits of the axial bearing.

Irrespective of whether this is based directly on the proposed seal according to the invention or the device or centrifugal compressor comprising such a seal, the dimensions or relations of dimensions mentioned below are individually from each other or in their entirety particularly preferred as experiments have shown a particularly advantageous sealing effect, in particular at more than 50,000 rpm:

| | | |
|---|---|---|
| External impeller | R1 | 5 mm ≤ R1 ≤ 100 mm, in particular |
| radius | | 8 mm ≤ R1 ≤ 25 mm |
| External radius at | R2 | 0.2 ≤ R2/R1 ≤ 1, in particular |
| the first side of the | | 0.7 ≤ R2/R1 ≤ 1 |
| internal sealing | | |
| body | | |
| External radius at | R3 | 0.1 ≤ R3/R1 ≤ 1, in particular |
| the second side of | | 0.6 ≤ R3/R1 ≤ 0.8, |
| the internal sealing | | preferably wherein R3 < R2 additionally |
| body | | applies in each case |
| Restrictor depth | a | 10 μm ≤ a ≤ 100 μm, in particular |
| | | 20 μm ≤ a ≤ 40 μm |
| Swirl chamber width | b | 5 ≤ b/a ≤ 500, in particular |
| | | 10 ≤ b/a ≤ 40 |
| Restrictor width | c | 5 ≤ c/a ≤ 500, in particular |
| | | 10 ≤ c/a ≤ 40, in particular |
| | | 17 ≤ c/a ≤ 24 |
| Restrictor distance | d | d = b + c |
| Swirl chamber | e | 5 ≤ e/a ≤ 500, in particular |
| depth | | 10 ≤ e/a ≤ 60 |
| Recess depth | f | 0 ≤ f/a ≤ 499, in particular |
| | | 0 ≤ f/a ≤ 59 or |
| | | if there is no recess, f = 0 or f/a = 0 |
| Ratio of swirl | | 0.5 ≤ b/c ≤ 1.5, in particular |
| chamber width b to | | b/c = 1 |
| restrictor width c | | |

In this respect, the external impeller radius corresponds to the radius of the impeller or its support plate directly at the internal sealing body or directly at the internal body. The external radius at the first side of the internal sealing body preferably corresponds to both a maximum external radius of the internal sealing body and the radial extent of a first step or a first radial external surface at the first side. Analogously, the external radius at the second side of the internal sealing body preferably corresponds to a minimum external radius of the internal sealing body and the radial extent of a last step or a last radial external surface at the second side, wherein a radial recess further reducing the external radius as intended is negligible.

Accordingly, at a recess depth of f=0, a recess is not present.

As already mentioned, the measurements of the restrictors and the measurements of the swirl chambers may vary, so that the measurements of the restrictors (a1 to a5, c1 to c5, d1 to d5) may deviate from one another or may be the same, and the measurements of the swirl chambers (b1 to b4, e1 to bis e4, f1 bis f4) may also deviate from one another or may be the same. Each of these measurements (a1 to a5, b1 to b4, c1 to c5, d1 to d5, e1 to e4, f1 to f4) may be chosen separately according to the dimensions or relations given in the table.

The features disclosed above are combinable as required, provided this is technically possible and they do not contradict one another.

Other advantageous developments of the invention are characterized in the dependent claims or illustrated in greater detail below together with the description of the preferred implementation of the invention with reference to the figures. In the drawings:

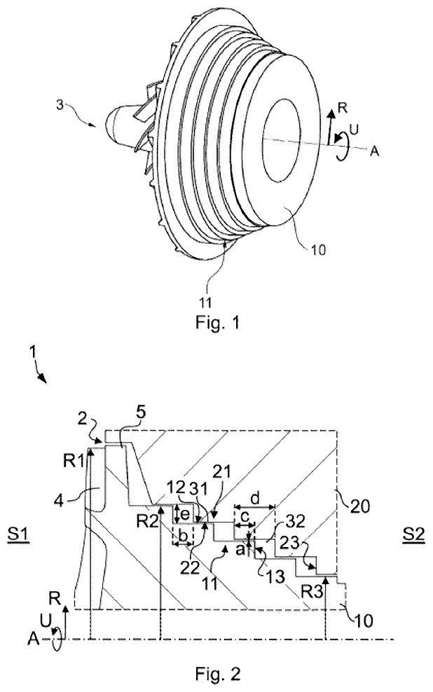

FIG. 1 shows a perspective diagram of a first variation of a seal;

FIG. 2 shows the first variation of the seal in a longitudinal section;

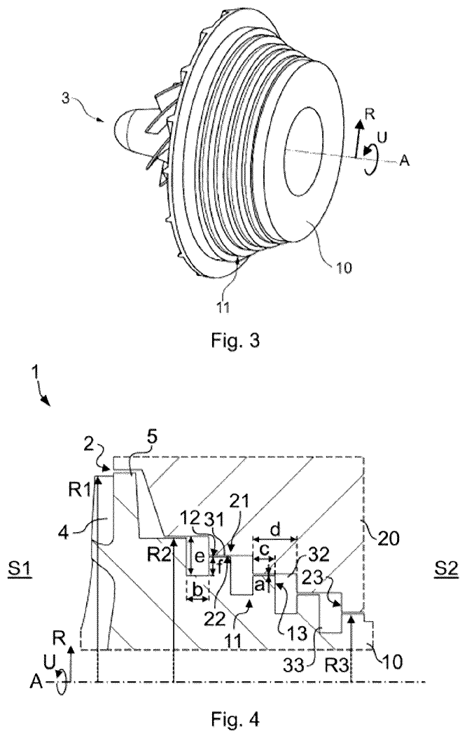

FIG. 3 shows a perspective diagram of a second variation of a seal;

FIG. 4 shows the second variation of the seal in a longitudinal section.

The figures are schematic examples. Same reference numerals in the figures indicate same functional and/or structural features.

FIGS. 1 and 2 show a first variation of a seal 1, exemplified by an impeller 3, in particular a centrifugal compressor, integrally formed as an internal body and internal sealing body 10, wherein FIG. 2 shows part of a longitudinal section along axis of rotation A. As such, impeller 3 has impeller blades 4 and a support plate 5 with which impeller 3 ends substantially flush with the surrounding external sealing body 20 formed as an external body, which forms a machine housing.

Seal 1 is exclusively formed by internal sealing body 10 and external sealing body 20, which are each integral, so that additional assembly steps for fixing further components are not necessary.

Internal sealing body 10 possesses a conical basic shape and is tapered along the axial direction from a first side S1 to a second side S2 in a step-wise manner across multiple steps 11. External sealing body 20 has a receiving space corresponding thereto, which is also tapered correspondingly from the first side S1 in the axial direction, i.e. along axis of rotation A to the second side S2, across multiple steps 21.

What is essential is that each step 11 of internal sealing body 10 is associated with a step 21 of external sealing body 20, which are, however, offset from one another in the axial direction, so that a radial external surface 12 of respective step 11 of internal sealing body 10 and a radial internal surface 22 of respective step 21 of external sealing body 20 thus abut against one another in a non-contact manner, i.e., a sealing gap 31 acting as a restrictor 31 is formed therebetween, but an axial external surface 13 of respective step 11 of internal sealing body 10 and an axial internal surface 23 of respective step 21 of external sealing body 20 are spaced apart to such an extent that a swirl chamber 32 is formed therebetween, in which a fluid flowing through radial gap 2, i.e., from first side S1 to second side S2, is swirled in a targeted manner, and the flow resistance for such a leakage flow of the fluid from first side S1 to second side S2 can be increased.

Impeller 3 shown in FIGS. 1 and 2 also possesses, adjacent to support plate 5 of impeller 3, an external impeller radius R1 which is both greater than an external radius R2 at first side S1 of internal sealing body 10 and greater than an external radius R3 at second side S2 of internal sealing body 10. As such, external radius R2 also corresponds to or determines radial external surface 12 adjacent to a first step 11 of internal sealing body 10 in the axial direction from first side S1 to second side S2, and external radius R3 also corresponds to or determines radial external surface 12 of a last step 11 out of four steps 11 of internal sealing body 10 in the axial direction from first side S1 to second side S2.

As such, each restrictor 31 or each sealing gap 31 possesses a corresponding restrictor depth a corresponding to the extension thereof in radial direction R and a corresponding restrictor width c corresponding to the extension thereof in the axial direction. As such, restrictor depths a as well as restrictor widths c of sealing gap 31 may deviate from one another. As an example, restrictor depths a are in a range of between 10 μm and 100 μm, respectively, wherein 5≤c/a≤500 applies to a ratio of restrictor widths c to respective restrictor depths a.

In addition, each of swirl chambers 32 is also defined by a respective swirl chamber depth e corresponding to the extension thereof in radial direction R and by a respective swirl chamber width b corresponding to the extension thereof in the axial direction. Again, swirl chamber depths e and swirl chamber widths b of the four swirl chambers 32 herein may deviate from one another, wherein, in the variation shown, swirl chamber width b and swirl chamber depth e are chosen such that a resulting ratio of swirl chamber depth e to restrictor depth a is preferably between 5 and 500.

By a rotation of internal sealing body 10 together or integral with impeller 3 about axis of rotation A and relative to external sealing body 20, in swirl chambers 32 and through sealing gaps 31 which connect swirl chambers 32 acting as restrictors 31, in a predetermined range of rotational speeds, a predetermined flow resistance is caused, so that only a small and likewise predetermined leakage flow of a fluid may flow from first side S1 to second side S2.

Seal 1 may be optimized further by reducing its weight. Therefore, a variation as shown in FIGS. 3 and 4 is also advantageous, which—unless indicated otherwise—matches the embodiment shown in FIGS. 1 and 2, so that the associated description applies analogously.

Therefore, in seal 1 as depicted in FIGS. 3 and 4, a radial recess 33 is provided on each of steps 11 of internal sealing body 11, having a width equal to swirl chamber width b, so that recess 33 extends respective swirl chamber 32 in radial direction R into internal sealing body 10. Compared to the variation according to FIGS. 1 and 2, recess depth f of recesses 33 in radial direction R corresponds to swirl chamber depth e therein, so that swirl chamber depth e and also the volume of swirl chambers 32 defined thereby is doubled in the variation according to FIGS. 3 and 4.

1. A non-contact dynamic seal (1) for sealing a radial gap (2) between a radially inward internal body and a radially outward external body surrounding the internal body in a circumferential direction (U), which are rotatable relative to one another about an axis of rotation (A),
wherein the seal (1) has an internal sealing body (10) providable on the internal body and an external sealing body (20) providable on the external body, with a receiving space for receiving the internal sealing body (10),
wherein the internal sealing body (10) has a conical basic shape and is tapered from a first side (S1) in the axial direction to a second side (S2) in a step-wise manner, wherein the steps (11) of the internal sealing body are each defined by a radial external surface (12) and an axial external surface (13),
wherein the receiving space has a conical basic shape corresponding to the internal sealing body (10), and is tapered from the first side (S1) in the axial direction to the second side (S2) in a step-wise manner, wherein the steps (21) of the receiving space are each defined by a radial internal surface (22) and an axial internal surface (23),
wherein each radial external surface (12) is associated with a radial internal surface (22), which are partially directly adjacent to one another in a non-contact manner forming a radial sealing gap (31), and each respective axial external surface (13) is associated with an axial internal surface (23) which is spaced apart in the axial direction, so that a swirl chamber (32) for receiving a fluid is formed between each of the axial external surfaces (13) and the axial internal surfaces (23), which are connected to one another via the radial sealing gaps (31) acting as restrictors (31) for the fluid,
wherein the swirl chambers (32) have a respective swirl chamber width (b) in the axial direction and a respective swirl chamber depth (e) in the radial direction, and
wherein the sealing gaps (31) each forming a restrictor (31) have a respective restrictor width (c) in the axial direction and have a respective restrictor depth (a) in the radial direction (R),
characterized in that
the swirl chamber widths (b) of the swirl chambers (32) vary from one another and/or the swirl chamber depths (e) of the swirl chambers (32) vary from one another, and/or
the restrictor depths (c) of the sealing gaps (31) vary from one another, and/or the restrictor widths (a) of the sealing gap (31) vary from one another.

2. The seal according to claim 1,
wherein, on all or at least part of the radial external surfaces (12), a respective radial recess (33) is provided, extending the respective swirl chamber (32) in the radial direction (R).

3. The seal according to claim 2,
wherein the respective radial recess (33) is delimited in the axial direction towards the first side (S1) by the respective axial external surface (13) or transitions into the same and/or is defined towards the second side (S2) by the respective axial internal surface (23) or flush therewith.

4. The seal according to claim 2,
wherein a respective radial recess (33) divides the respective radial external surface (12) in the axial direction into a first portion defined by the recess (33) with a first axial width (b) and a second portion free from the recess with a second axial width (c).

5. The seal according to claim 1, wherein the swirl chambers (32) are rectangular in the basic shape of their cross-section.

6. The seal according to claim 1,
wherein the internal sealing body (10) is integral, and/or
wherein the external sealing body (20) is integral.

7. The seal according to claim 1,
wherein the swirl chambers (32) and the radial sealing gaps (31) are formed to produce a predetermined axial force at the internal sealing body (10) by the fluid at a predetermined rotation of the internal body towards the external body.

8. A device, in particular a centrifugal compressor, having a housing and an impeller (3) mounted in the housing rotatably about an axis of rotation (A),
wherein the impeller (3) is integrally formed as an internal body rotatable about the axis of rotation (A) or fixed to a shaft which is formed as the internal body rotatable about the axis of rotation (A),
wherein the housing is integrally formed as a radially outward external body surrounding the internal body in the circumferential direction (U) or receives the external body,
wherein a radial gap (2) formed between the internal body and the external body is sealed by a seal (1) according to claim 1.

9. The device according to claim 8,
wherein the internal sealing body (10) is fixed to the internal body or the internal body is integrally formed as the internal sealing body, and/or
wherein the external sealing body (20) is fixed to the external body or the external body is integrally formed as the external sealing body.

10. The device according to claim 8,
wherein the swirl chambers (32) and the radial sealing gaps (31) are formed to produce a predetermined axial force for compensation and/or for reduction of opposing axial forces acting on the internal sealing body (10) and/or the impeller (3) at the internal sealing body (10) by the fluid at a predetermined rotation and/or at a predetermined operating point of the impeller (3).
